(19) United States
(12) Patent Application Publication
(10) Pub. No.: US 2024/0238918 A1
(43) Pub. Date: Jul. 18, 2024

(54) SLUG REMOVAL SYSTEM FOR A LASER CUTTER

(71) Applicant: Connaughty Industries, Inc., dba Rushford Manufacturing, Rushford, MN (US)

(72) Inventors: Jay Thomas Hisel, Lansing, IA (US); Kenneth Gene Connaughty, Peterson, MN (US)

(73) Assignee: Connaughty Industries, Inc., dba Rushford Manufacturing, Rushford, MN (US)

(21) Appl. No.: 18/412,407

(22) Filed: Jan. 12, 2024

Related U.S. Application Data
(60) Provisional application No. 63/504,677, filed on May 26, 2023.
(60) Provisional application No. 63/576,067, filed on Jan. 12, 2023.

(51) Int. Cl. B23K 37/08; B23K 26/38

(52) U.S. Cl. CPC B23K 37/08; B23K 26/38

(57) ABSTRACT

A laser cutting assembly with a laser cutter, a worktable including a plurality of slats, and a slug removal assembly. The slug removal assembly includes a movable support, at least one scraper plate, and a resilience system linking the at least one scraper plate to the movable support. The at least one scraper plate is configured to contact a corresponding one of the plurality of slats. The movable support is configured to move across the worktable such that the at least one scraper plate contacts a corresponding one of the plurality of slats.

### CROSS-REFERENCE TO RELATED APPLICATIONS

This application claims the benefit of U.S. Provisional Application No. 63/504,677, filed on May 26, 2023; and U.S. Provisional Application No. 63/576,067, filed on Jan. 12, 2023, the disclosures of which are hereby incorporated by reference in their entireties. To the extent appropriate, a claim of priority is made to each of the above-disclosed applications.

### BACKGROUND

Laser cutters are advanced fabrication tools that employ a focused, high-powered laser beam to precisely cut, engrave, or etch materials. At a high level, these devices operate by directing the coherent light emitted from a laser tube onto a workpiece using a system of mirrors and lenses. Typically, a computer numerical control (“CNC”) system orchestrates the movement of the laser head, guiding it along a designated path according to a digital design file. Laser cutters are favored for their unparalleled accuracy, efficiency, and versatility, as they can process a wide range of materials including wood, plastics, textiles, metals, and more. Their non-contact cutting process minimizes material waste and reduces the risk of damage, making laser cutting an invaluable tool for industries such as manufacturing, architecture, and art.

Slugs are small pieces of material that are removed or cut away from the workpiece during the cutting process. Slugs often have molten edges from the cutting process which can cause them to stick to the worktable. The slugs can cause cutting issues if not removed between cutting operations. If left on the worktable, slugs can interfere with proper seating of workpieces on the table. Tilted workpieces may not cut correctly and often lead to excessive scrap. In less severe cases, slugs can cause workpiece appearance issues and lead to increased post-processing work. To mitigate slug formation, it is crucial to maintain a clean cutting environment.

Cleaning slugs from a laser cutter worktable is a vital maintenance task that ensures optimal performance and prolongs the equipment's lifespan. There are several slug cleaning/removal methods known in the art. These include chiseling, wire brushing, grinding, and sandblasting. These methods often require significant down time. Machine assisted wire brushing is also known in the art. While this method can reduce down time, wire brushes wear quickly and require frequent replacement. There is a need for a slug removal system that minimizes down time and avoids the need for frequent replacement.

### SUMMARY

Aspects of the present disclosure relate to a laser cutting assembly having a laser cutter, a worktable including a plurality of slats, and a slug removal assembly. The slug removal assembly includes a movable support, at least one scraper plate, and a resilience system linking the at least one scraper plate to the movable support. Each of the at least one scraper plates is configured to contact a corresponding one of the plurality of slats. The movable support is configured to move across the worktable such that the at least one scraper plate contacts a corresponding one of the plurality of slats. In certain examples, the resilience system is configured to provide an elastic resistance between the at least one scraper plate and a corresponding one of the plurality of slats. In certain examples, the laser cutting assembly includes slug detection sensors. In certain examples, the at least one scraper plate is a plurality of scraper plates equal to the plurality of slats. In certain examples, the slug removal assembly is integral to the laser cutter. In certain examples, the slug removal assembly is separate from the laser cutter. In certain examples, the slug removal assembly is configured to operate autonomously. In certain examples, the movable support is a robotic arm.

Additional aspects of the present disclosure relate to a slug removal system having at least one scraper plate and a resilience system linked to the at least one scraper plate. The resilience system is configured to provide the at least one scraper plate an elastic resistance upon contact with the worktable. The at least one scraper plate is configured to contact a corresponding one of a plurality of slats on the worktable. The slug removal system is configured to move across the worktable such that the at least one scraper plate contacts a corresponding one of the plurality of slats. In certain examples, the resilience system is configured to provide a sufficient resistance between the at least one scraper plate and a corresponding one of the plurality of slats such that slugs may be removed. In certain examples, the resilience system is configured to provide a limited resistance between the at least one scraper plate and a corresponding one of the plurality of slats such that neither the at least one scraper plate nor the corresponding one of the plurality of slats are damaged. In certain examples, the resilience system is a spring. In certain examples, the slug removal system selectively moves about the worktable.

Additional aspects of the present disclosure relate to a scraper plate for a slug removal system on a laser cutter. The scraper plate has a body having a first face and second face, a notch on a first end of the body, and a connection element near a second end, the second end being opposite the first end. At least part of a length of the notch has a fillet extending from the first face to the second face and the fillet is configured to contact a slat on a worktable. In certain examples, the connection element includes one or more slots. In certain examples, the body is rectangular. In certain examples, the notch is a trapezoidal shape. In certain examples, the fillet extends across the top side and at least partially along the non-parallel sides of the of the trapezoidal shaped notch. In certain examples, the scraper plate includes a catch feature for pulling slugs away from the slats.

Another aspect of the present disclosure relates to a method for cleaning a worktable of a laser cutter. The method includes moving a movable support across a worktable, where the movable support has a slug removal system including at least one scraper plate. The method includes at least one scraper plate contacting a corresponding worktable slat such that an interference is created when moving the movable support across the worktable. The method includes elastically deflecting the at least one scraper plate in response to the interference. In certain examples, the method includes the at least one scraper plate elastically deflects upon reaching a force being sufficiently high to detach slugs from the worktable slat, the force being sufficiently low to avoid damaging the worktable slat.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows.

FIG. 1 is an example of a laser cutter assembly in accordance with the principles of the present disclosure.

FIG. 2 shows the laser cutter assembly of FIG. 1 with a slug removal assembly in a lowered position.

FIG. 3 is a perspective view of an example slug removal assembly in accordance with the principles of the present disclosure.

FIG. 4 is a front view of the slug removal assembly of FIG. 3.

FIG. 5 is a top view of the slug removal assembly of FIG. 3.

FIG. 6 is bottom view of the slug removal assembly of FIG. 3.

FIG. 7 is a side view of the slug removal assembly of FIG. 3.

FIG. 8 is a front perspective view of an example slug removal system in accordance with the principles of the present disclosure.

FIG. 9 is a rear perspective view of the slug removal system of FIG. 8.

FIG. 10 is a front view of an example scraper plate in accordance with the principles of the present disclosure.

FIG. 11 is a side view of the scraper plate of FIG. 10.

FIG. 12 is a front view of an example movable support in accordance with the principles of the present disclosure.

FIG. 13 is a rear view of the movable support of FIG. 12.

FIG. 14 is a perspective view of the slug removal assembly of FIG. 3 with the slug removal system of FIG. 8 removed.

FIG. 15 is another embodiment of a slug removal assembly in accordance with the principles of the present disclosure.

FIG. 16 is yet another embodiment of a slug removal assembly in accordance with the principles of the present disclosure.

FIG. 17 is a perspective view of an example slug removal system moving across a worktable slat in accordance with the principles of the present disclosure.

FIG. 18 is a side view of an example slug removal system elastically deflecting from contact with a slat in accordance with the principles of the present disclosure.

FIG. 19 is a front view of another example scraper plate in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

One aspect of the present disclosure relates to a slug or debris removal system that can be adapted for reliable use with any work surface and can be automated to maximize efficiency. The slug or debris removal system may be adapted for use in any number of cutting fields beyond laser cutting. For example, additional embodiments of the present disclosure include a slug or debris removal system for a waterjet cutter, a plasma cutter, a flame cutter, and a welder. For ease of discussion, the disclosure refers to an example application of the slug removal system for a laser cutter, but the same or similar slug removal system can also be used for such other applications to form additional embodiments of the present disclosure.

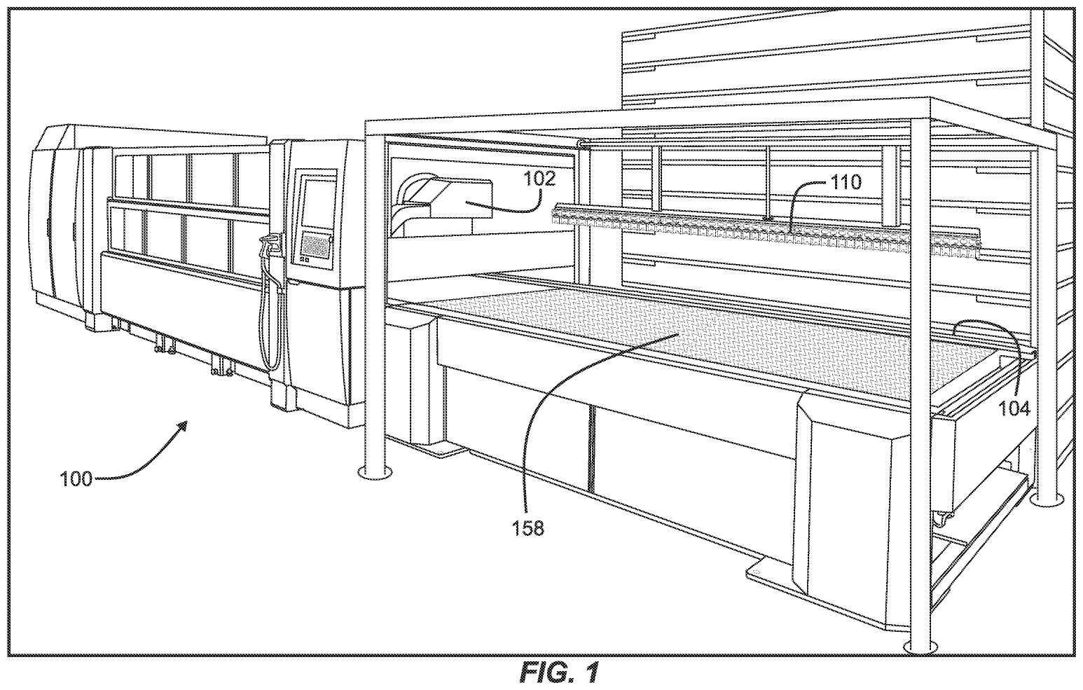

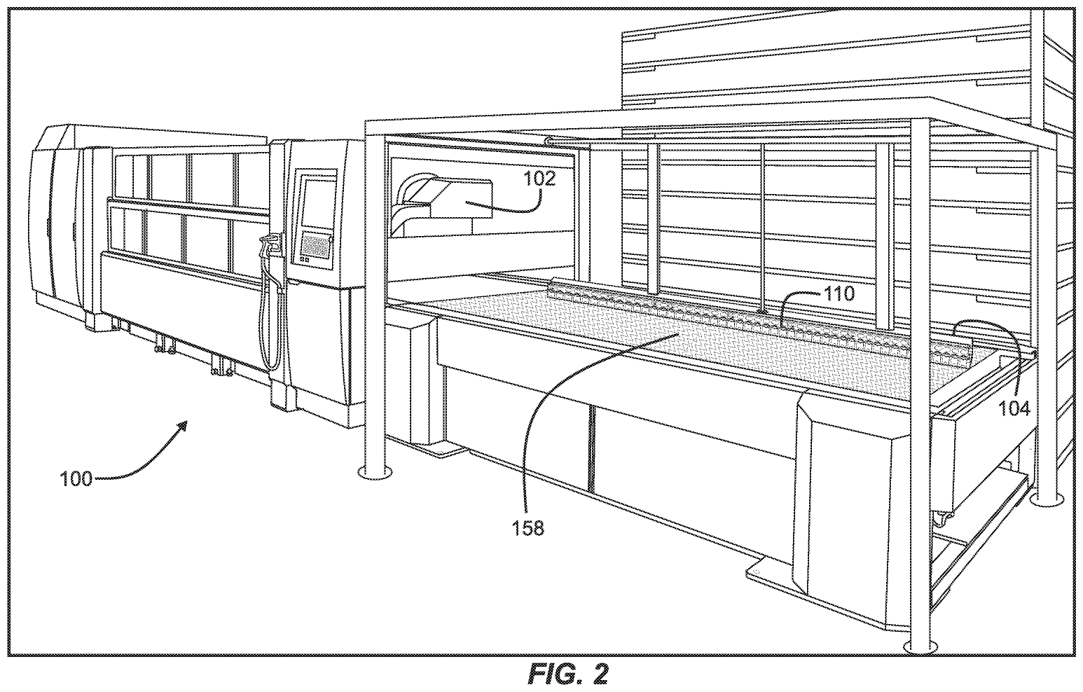

FIG. 1 shows the outside of a typical laser cutting assembly 100 that includes a covering commonly used for improved safety in manufacturing facilities. The example laser cutting assembly 100 of FIG. 1 includes laser cutter 102, worktable 104, and a slug removal assembly 110. The laser cutting assembly 100 has automated slug removal capabilities in which the slug removal assembly 110 may be operated automatically between cutting cycles. The same laser cutting assembly 100 can be seen in FIG. 2 with the slug removal assembly 110 in a lowered cleaning state. It should be appreciated, however, that many different laser cutters exist and the inventive aspects of the present disclosure may be adapted to suit any specific laser cutter and other manual processes.

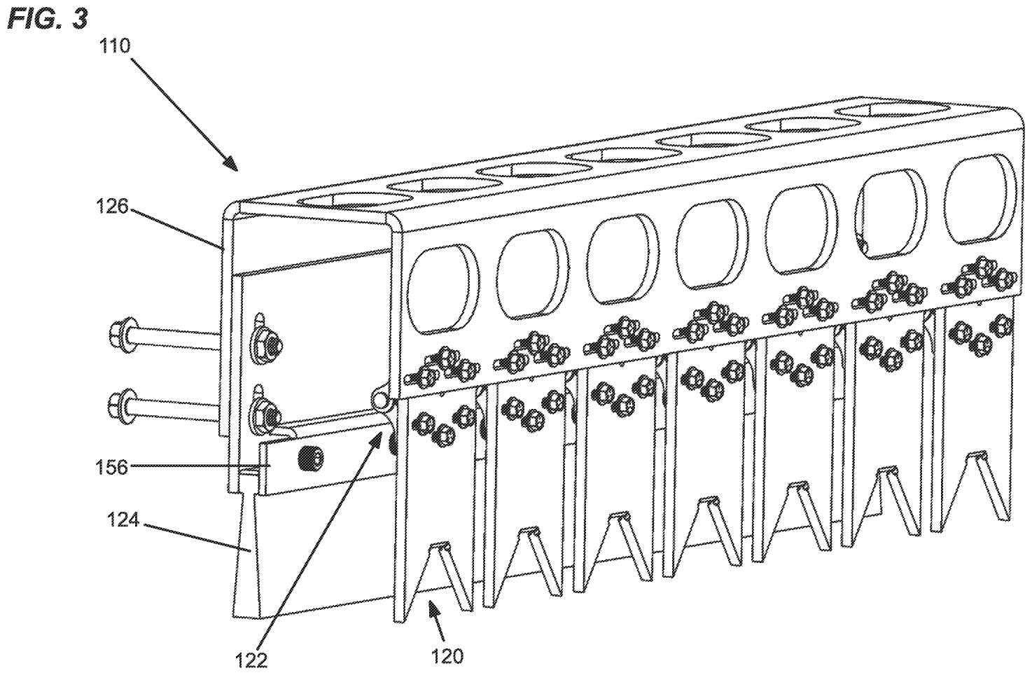

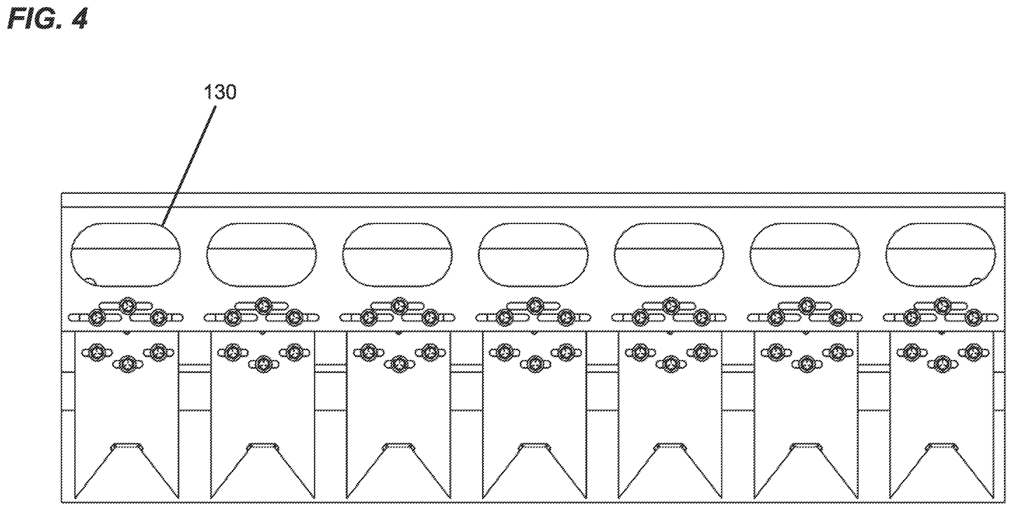

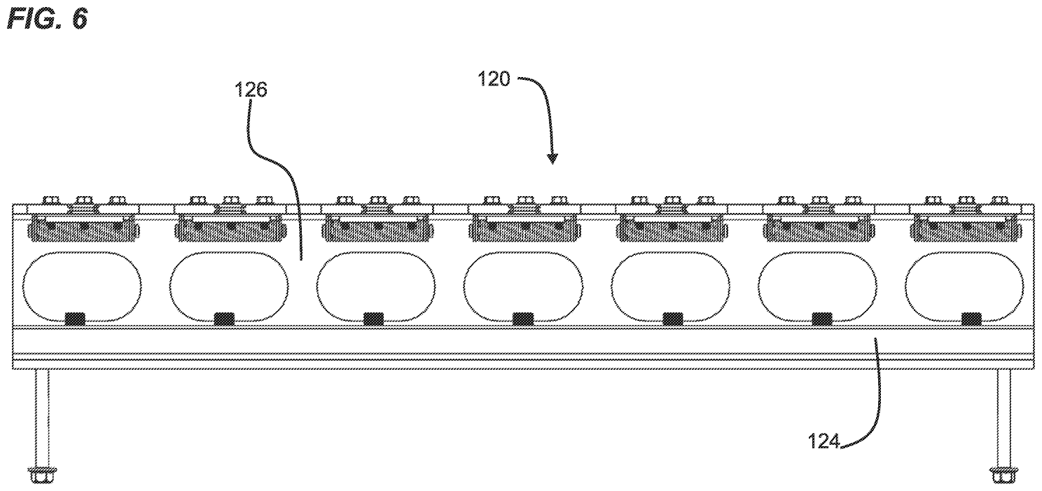

FIGS. 3-7 show an example slug removal assembly 110 that includes a movable support 126 and a slug removal system 120. The movable support 126 may link the slug removal system 120 with the laser cutter 102. In one example, the laser cutter 102 is capable of controlling the slug removal assembly 110 via an automated routine or user input. In other instances, the slug removal assembly 110 may be a separate piece of equipment running in tandem with the laser cutter 102 or independent from the laser cutter 102. In another example, the slug removal assembly 110 may be manually operated. The slug removal assembly may attach to a frame surrounding a loading station at the entrance of the laser cutter.

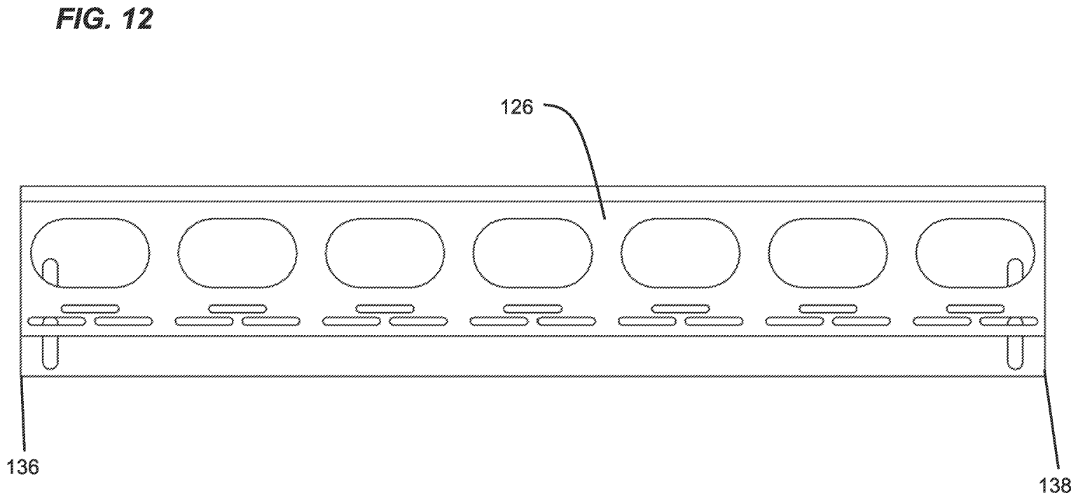

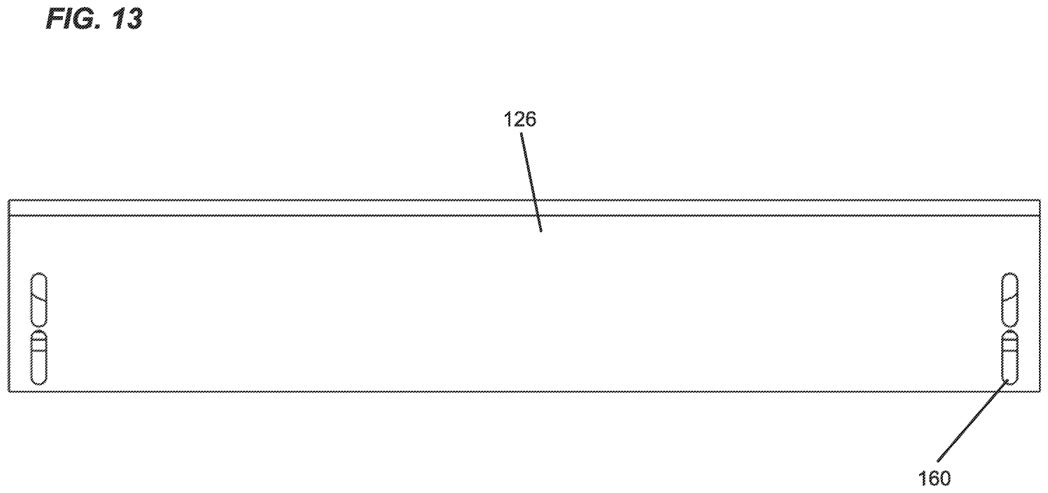

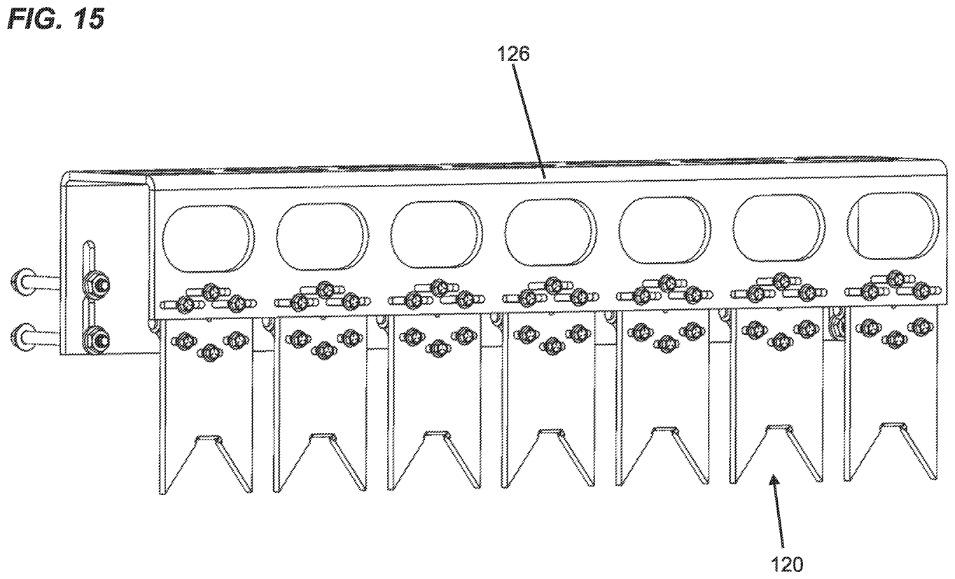

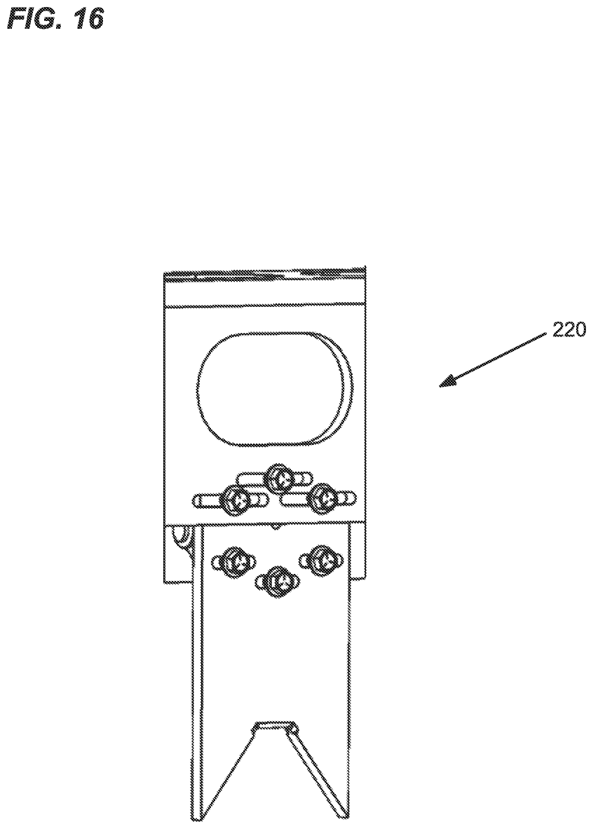

The movable support 126 may take many forms depending on the space limitations, dimensions of the worktable 104, and laser cutter 102 attachment requirements. FIGS. 12 and 13 show the movable support 126 of the slug removal assembly 110. The movable support 126 has a channel-shaped design with a length that extends from a first end 136 to a second end 138. The length of the movable support 126 may vary. In one example, the length may be sufficient to cover the length of worktable 104 such that the slug removal assembly 110 can clean the worktable 104 in a single pass. In another example (as can be seen in FIG. 16), the movable support 126 may be a minimum length to clean a single slat 158 of the worktable 104. The channel design is not required. The movable support 126 may take any form sufficient to link the slug removal system 120 with the laser cutter 102. For example, the movable support 126 may be a robotic arm, shaft, bridge, cantilever, etc. The channel design may provide some benefits such as providing clearance for movement (deflection) in the slug removal system 120, as will be discussed later. Additionally, the channel design facilitates the inclusion of a brush 124 as part of the example slug removal system 120 shown in FIGS. 3-7. Alternatively, FIG. 15 shows an example slug removal assembly 110 using a channel design without the brush 124.

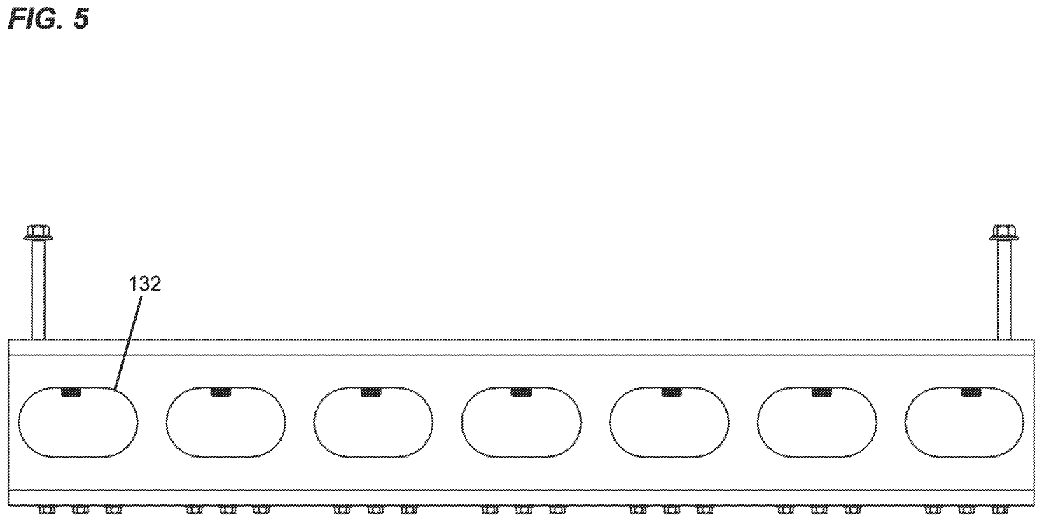

FIG. 12 shows the front view of the movable support 126 having large regularly spaced front openings 130. Similarly, FIG. 5 shows a top view of the movable support 126 with regularly spaced top openings 132. The front and top openings 130, 132 have several benefits but are not required. First, the openings 130, 132 reduce weight of the slug removal assembly 110. Second, the openings 130, 132 enable easy access to any attachment means that may be used either in attaching the movable support 126 to the laser cutter 102 or in attaching the slug removal system 120 to the movable support 126.

FIG. 13 shows an example rear view of the movable support 126 that includes support attachment points 160. The movable support 126 may be connected to additional equipment in order to facilitate movement about the worktable 104. For example, the movable support 126 may attach to additional arms or components that drive the movable support 126 between a home position and a cleaning routine. The support attachment points 160 may include through holes for bolting/fastening, weld points, or any other means of attachment.

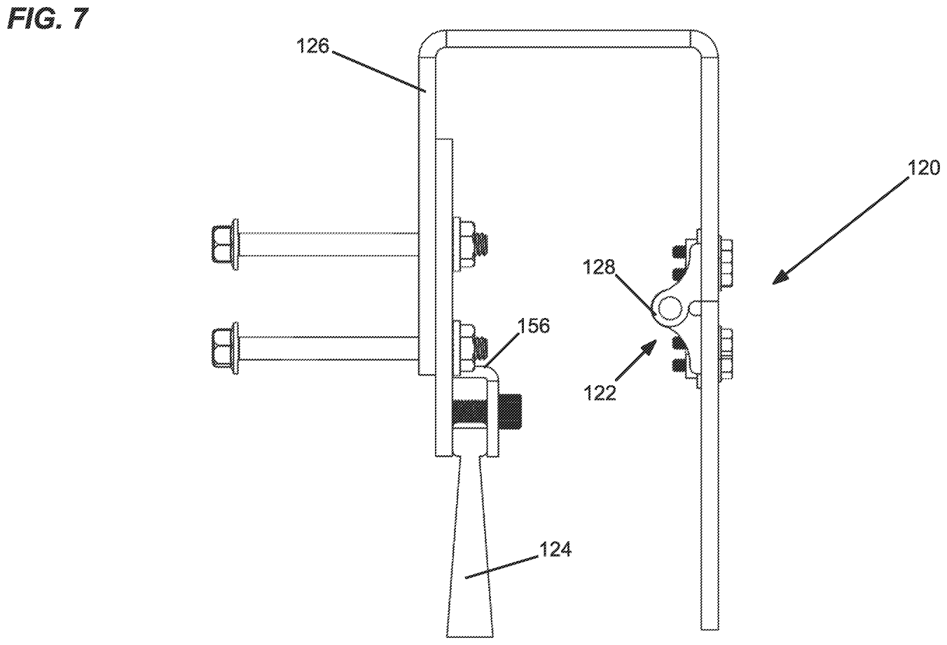

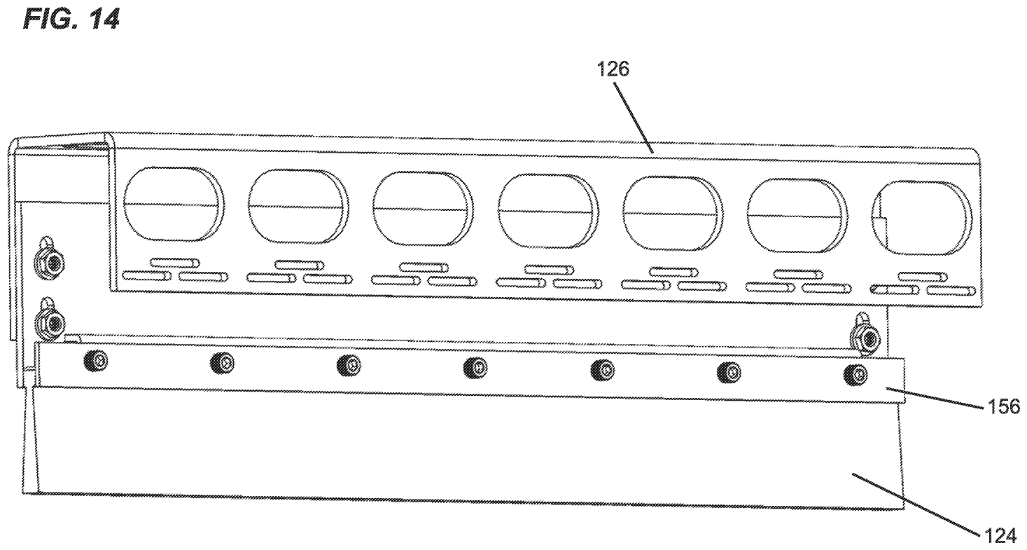

FIG. 7 shows the brush 124 attached to the movable support 126 by an attachment bar 156. The attachment bar 156 may be linked to or integral to the movable support 126. Brush 124 can wear over time and may need to be repositioned or replaced in order to remain effective. The attachment bar 156 enables the brush 124 to be easily repositioned using the openings 130, 132 to access the attachment means. FIG. 14 shows an example of the movable support 126 and brush 124 without any other components.

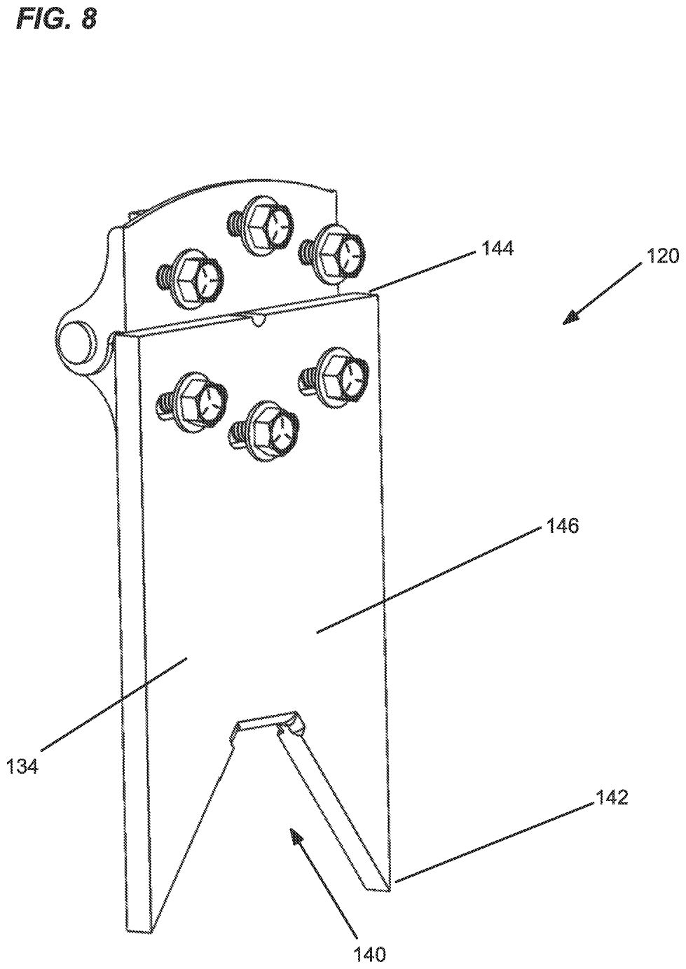

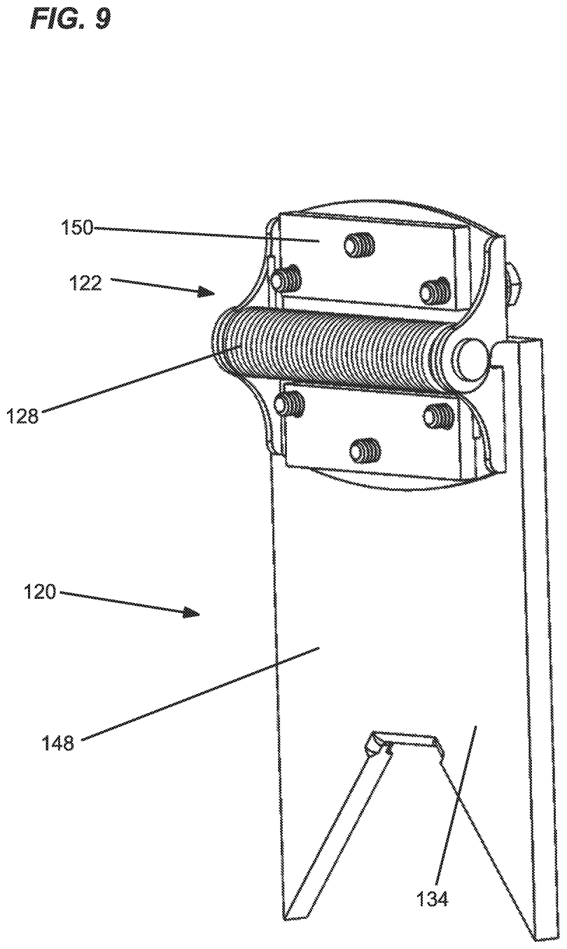

One example of the slug removal system 120 is shown in FIGS. 8 and 9. The slug removal system 120 includes a resilience system 122 and a scraper plate 134. Optionally, the slug removal system 120 may also include the brush 124 (shown in FIGS. 3-7) or other features that aid in the removal of slugs. The slug removal system 120 may attach to the movable support 126, as discussed above, or it may be used as part of a manual system, in conjunction with other attachment means. In one example, the slug removal system 120 attaches to a shaft and can be used like a rake across the slats 158 of the worktable 104. In another example, the slug removal system 120 attaches to a robotic arm and may be programmed to move about a worktable 104. The robotic arm may be programmed to identify slugs and target only specific areas in need of cleaning.

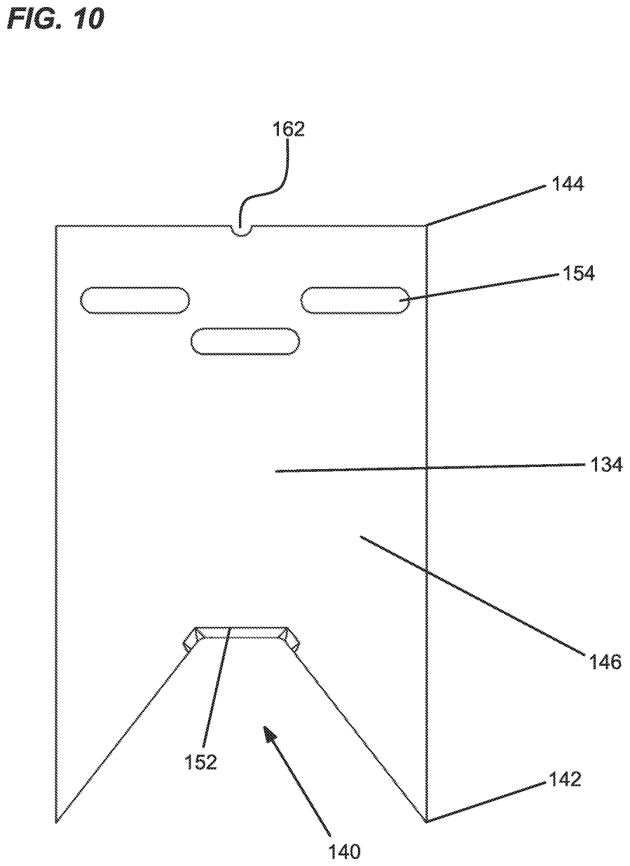

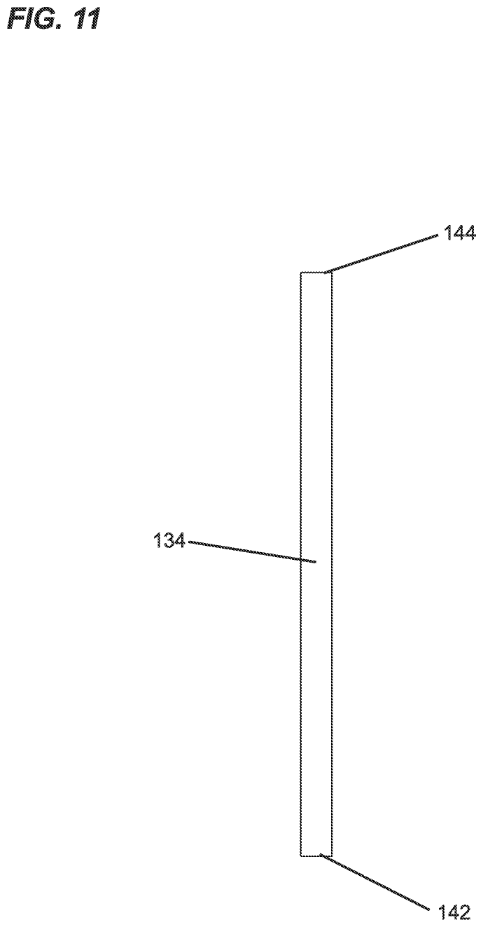

The scraper plate 134, shown in FIGS. 10 and 11, has a first end 142 and a second end 144. The first end 142 is intended to make contact with the slats 158 of worktable 104. The second end 144 is intended to connect to the resilience system 122. The first end 142 includes a notch 140. The notch 140 may be of any shape. In FIG. 10, the notch 140 is trapezoidal. The slat 158 of the worktable 104 is meant to contact the notch 140 of the scraper plate 134. The non-parallel sides of the notch 140 facilitate positioning of the scraper plate 134 on the slat 158. Primary contact with the slat 158 occurs on a top side 152 of the notch 140. The top side 152 is preferably shaped to reduce wear on the slats 158. In one example, the top side 152 has a fillet extending from a first face 146 to a second face 148. The fillet may also continue along the non-parallel sides. The length of the top side 152 may vary depending on several factors. As worktable slats 158 are worn, they can become misshaped, and a longer top side 152 of a scraper plate 134 can accommodate more slat variation. On the other hand, a short top side 152 length can improve slug removal along the sides of the slat 158. In one example, the top side 152 of the scraper plate 134 has a length less than a quarter inch. In another example, the top side 152 has a length between a quarter inch and a half inch. In another example, the top side 152 has a length between a half inch and three quarters of an inch.

The second end 144 of scraper plate 134 may include a connection element to link to the resilience system 122. In FIG. 10, slots 154 are shown. FIGS. 8-9 show the slots 154 used for bolting the scraper plate 134 to the resilience system 122. In this example, a threaded plate 150 is used to secure the ends of the bolts. The threaded plate 150 can be used to in securing the scraper plate 134 to the resilience system 122 and for securing the resilience system 122 to the movable support 126. Other means of connection are contemplated as well. For example, other fasteners, adhesives, welding, snap fitting, clamping, use of magnets, etc. can all be used to link the scraper plate 134 to the resilience system 122. Bolts and other removable connection means are preferable for occasional maintenance or replacement of the scraper plates. The slots 154 also provide horizontal adjustment capabilities, which can help accommodate individual worktable slat 158 positions that vary. An indent 162 on the second end 144 may be used for centering scraper plates over slats as a reference feature.

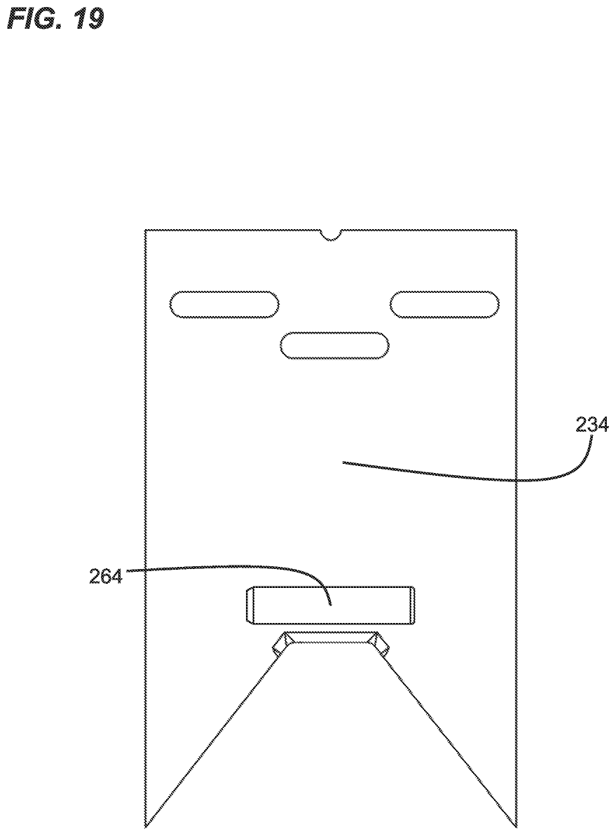

Another example scraper plate is shown in FIG. 19. Scraper plate 234 includes catch feature 264. In some cases, slugs may not fall off from the impact of scraper plate 234 alone. When slugs attach to the slats 158 with unusually high retention forces, a catch feature 264 may be used to pull the slug from the slat 158. The catch feature 264 may be any feature that catches hard to remove slugs and effectively pulls them free from the slats 158. For example, the catch feature 264 may be a hook, a shaped plate, a rod, etc. In the example shown, the catch feature 264 is a cylindrical rod extending laterally across the front face of scraper plate 234.

The resilience system 122 provides resistance between the scraper plate 134 and the worktable 104 as the scraper plate 134 moves across a given slat 158 on worktable 104. The resilience system 122 provides sufficient resistance to remove slugs, while ensuring that the slug removal system 120 and worktable 104 are not damaged by an overly rigid contact. Preferably, the resilience system 122 provides an elastic resistance such that the scraper plate 134 deflects at a desired threshold force against it and then returns to an original and undeformed state after contact with the slat 158 is ended. The desired resistance may be achieved in a number of ways. For example, coil springs, torsion springs, leaf springs, elastic cables, pneumatic or hydraulic systems, foam, or even shape-memory alloys can all provide an elastic resistance. Torsion springs offer a relatively cheap and easily replaceable option for providing elastic resistance.

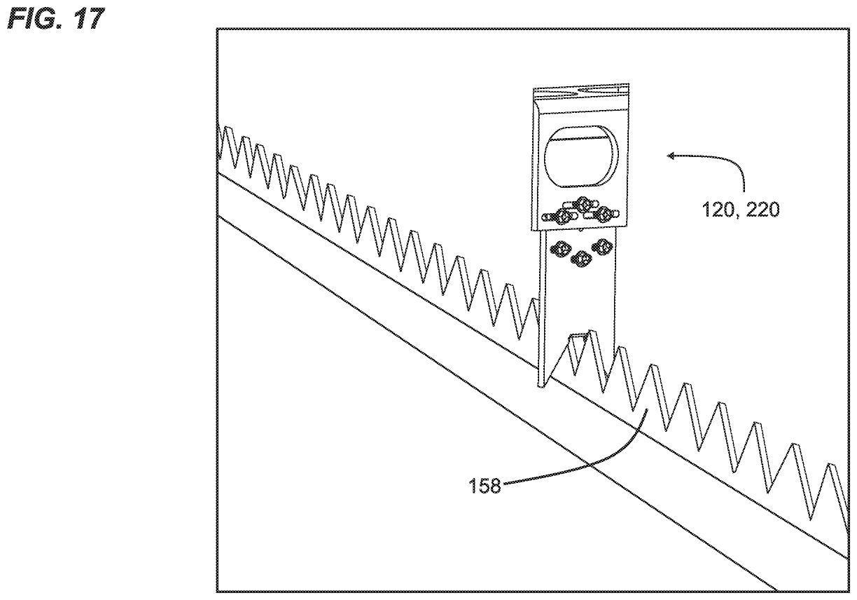

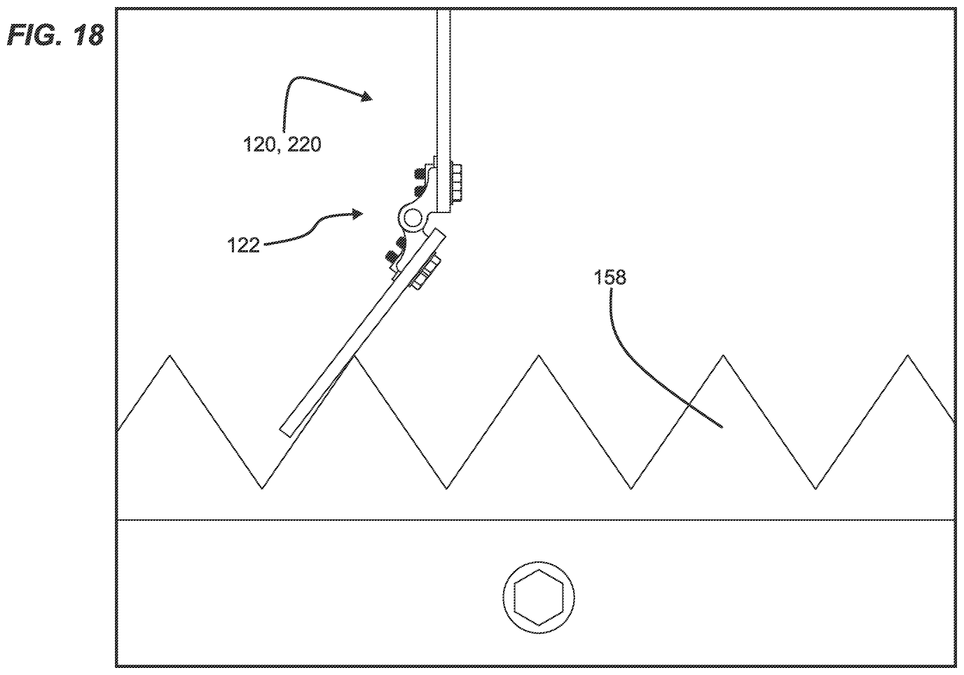

FIGS. 8-9 show the use of spring 128, a torsion spring, as an example of the resilience system 122 positioned on the second face 148 of the scraper plate 134. This example is meant to illustrate one possibility of a resilience system 122 and not be limiting to the use of other elastic mechanisms in other positions. As another example, an elastic band or cable could be positioned on the front side of the slug removal system 120 attaching to the first face 146 of the scraper plate 134. FIG. 18 shows an example of the resilience system 122 in action as the slug removal system 120, 220 passes across teeth of the slat 158. The resilience system 122 begins to deflect the scraper plate 134 until the scraper plate 134 is deflected to a point where there is clearance for the scraper plate 134 to continue forward over the peak of the slat 158. Once the scraper plate 134 clears the peak, the resilience system 122 springs the scraper plate 134 back to its original position relative to the rest of the slug removal system 120. In this example, the slug removal system 120, 220 is shown with a spring 128. FIG. 17 provides a view of the scraper plate 134 in its original position in between peaks of the slat 158.

Depending on the speed of travel across the slats 158, the resilience system 122 may or may not return the scraper plate 134 to its original position between teeth of the slat 158. When the movable support 126, or other mechanism, is traveling fast enough, the scraper plate 134 contacts the peak of the next slat 158 as the scraper plate 134 is still springing back from contact with the previous tooth. As a result, the contact with the next tooth can occur very quickly and cause increased slat vibration which further assists in the removal of the slugs.

The amount of resistance desired in the resilience system 122 may vary depending on a number of factors. One consideration is the difficulty of removing slugs, which could vary depending on the type of metal being cut, the thickness of the metal, the design of the worktable 104, the laser parameters, etc. Another factor is the size and design of the scraper plate 134 and level of interference between the scraper plate 134 and the worktable slat 158. Many worktable slats 158 include periodic peaks and troughs. The peaks may be referred to as teeth. This means that, as the scraper plate 134 passes along the slat 158, there will be a periodic resistance that occurs each time the scraper plate 134 contacts the next peak of a slat 158. The most important surface to clean on a worktable 104 is the peak of the slat 158, the part that will contact the material to be cut. If debris, such as slugs, are left on the peak of a worktable slat 158, then sheet metal, or other materials to be cut, will be angled relative to the worktable 104 surface and the focus point of the laser may be misaligned due to the change in height. In one example, the scraper plate 134 contacts at least the top inch of the slat 158. In another example, the scraper plate 134 contacts the top half inch to one inch of the slat 158. In another example, the scraper plate 134 contacts the top quarter inch to half inch of the slat 158. In another example, the scrape plate contacts less than the top quarter inch of the slat 158. FIG. 17 shows an example of the slug removal system 120, 220 just before making contact with an individual tooth on the slat 158.

The resilience system 122 may be designed to be a weak point in the system, such that if the equipment were to get caught at a scraper plate 134, the resilience system 122 would fail before damage to other equipment would occur. In the example shown, the spring 128 would fail first. The spring 128 could then be easily replaced with minimal cost.

The slug removal assembly 110 may be integrated with the laser cutter 102, as shown in FIG. 2. The slug removal assembly 110 may also be independent from the laser cutter. For example, in an autonomous setup, there may be a separate station by which cut parts are removed and worktables are scrapped, before being reloaded and sent back to the laser cutter 102. In either case, the slug removal system 120 begins on one end of a worktable 104 and travels the length of the slats 158 across the worktable 104 until the slug removal system 120 reaches the other end. The process of positioning and moving the slug removal system 120 can be done automatically through the use of the movable support 126 described earlier. In some cases, the slug removal system 120 may take multiple passes. The decision whether to make multiple passes may be automated and based on slug detection sensors. The slug detection sensors may include any type of detection device including cameras, infrared sensors, capacitive and inductive sensors, magnetic sensors, laser scanners, or other object recognition systems.

Alternatively, a slug removal system 220, shown in FIG. 16, includes only a single scraper plate 134. In this example, the slug removal system 120 may be connected to a movable support 126 such as a robotic arm and used to selectively remove slug without having to travel across each slat 158. Using slug detection sensors, the slug removal system 220 can reduce cleaning time by targeting only the areas in need of cleaning. A manual version of slug removal system 220 is also possible. For example, the slug removal system 220 could be attached to a movable support 126 such as a shaft and used for manual spot removal of slugs.

By cycling worktables 104, laser cutting operations may be expedited. Workpieces can be loaded, unloaded, and worktables may be cleaned while the laser cutter 102 is running. For example, A plurality of worktables 104 may be queued for cutting in a stack, or other configuration, such that, as one worktables 104 exits the laser cutter 102, another worktable 104 from the queue may roll into position to be cut. In this way, much of the cutting operation can be automated and repairs can occur in line with the manufacturing process. In one example, two worktables 104 rotate between a loading stage and a cutting stage such that, while a part is being cut in the cutting stage, another part can be loaded in the loading stage.

A method for cleaning a laser cutter 102 worktable 104 includes moving a movable support 126 across a worktable 104, the movable support 126 having slug removal system 120 including at least one scraper plate 134. The at least one scraper plate 134 contacts a corresponding worktable 104 slat 158 such that an interference is created when moving the cleaning arm across the worktable 104. The scraper plate 134 elastically deflects in response to the interference. Variations on this method are also considered. The interference may be periodic. The desired deflection force may be sufficiently high to detach slugs from the worktable slat 158 before the scraper plate 134 elastically deflects. The desired deflection force may be sufficiently low to avoid damaging the worktable slat 158. The movable support 126 may make multiple passes across the worktable 104. The movable support 126 may selectively move across locations with slugs. The slug removal assembly 110 (movable support 126 plus slug removal system 120) may be detached from the laser cutter 102. The movable support 126 may move across the worktable 104 automatically, without user input. Many variations or additional steps are also provided throughout the disclosure and are intended to be combined in any number of ways.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A laser cutting assembly comprising:
a laser cutter;
a worktable including a plurality of slats;
a slug removal assembly including:
a movable support configured to move across the worktable;
at least one scraper plate, each of the at least one scraper plate configured to contact a corresponding one of the plurality of slats when the movable support moves the at least one scraper plate across the worktable; and
a resilience system linking the at least one scraper plate to the movable support.

2. The laser cutting assembly of claim 1, wherein the resilience system is configured to provide an elastic resistance between the at least one scraper plate and a corresponding one of the plurality of slats.

3. The laser cutting assembly of claim 1, wherein the laser cutting assembly includes a slug detection sensor.

4. The laser cutting assembly of claim 1, wherein the slug removal system includes a quantity of scraper plates that equals a quantity of the slats of the worktable.

5. The laser cutting assembly of claim 1, wherein the slug removal assembly is integral to the laser cutter.

6. The laser cutting assembly of claim 1, wherein the slug removal assembly is separate from the laser cutter.

7. The laser cutting assembly of claim 1, wherein the slug removal assembly is configured to operate autonomously.

8. The laser cutting assembly of claim 1, wherein the movable support is a robotic arm.

9. The slug removal system of claim 1, wherein the slug removal assembly selectively moves about the worktable.

10. A slug removal system configured to be moved across a worktable, the slug removal system comprising:
a scraper plate configured to contact a slat on a worktable; and
a resilience system linked to the scraper plate and configured to provide the scraper plate an elastic resistance upon contact with the slat.

11. The slug removal system of claim 10, wherein the resilience system is configured to provide a sufficient resistance between the scraper plate and the slat such that slugs may be removed.

12. The slug removal system of claim 10, wherein the resilience system is configured to provide a limited resistance between the scraper plate and the slat such that neither the scraper plate nor the slat are damaged.

13. The slug removal system of claim 10, wherein the resilience system comprises a spring.

14. A scraper plate for a slug removal system on a laser cutter, the scraper plate comprising:
a body having a first face and second face;
a notch on a first end of the body, at least part of a length of the notch having a fillet extending from the first face to the second face, the fillet configured to contact a slat on a worktable; and
a connection element near a second end of the body, the second end being opposite the first end.

15. The scraper plate of claim 14, wherein the connection element includes one or more slots.

16. The scraper plate of claim 14, wherein the body is rectangular.

17. The scraper plate of claim 17, wherein the notch is a trapezoidal shape and wherein the fillet extends across a top side and at least partially along non-parallel sides of the of the trapezoidal shaped notch.

18. The scraper plate of claim 14, wherein the scraper plate includes a catch feature configured to pull slugs from slats.

19. A method for cleaning a worktable of a laser cutter, the method comprising:
moving a movable support across a worktable, the movable support having a slug removal system including at least one scraper plate;
contacting a worktable slat with the at least one scraper plate such that an interference is created when moving the movable support across the worktable; and
elastically deflecting the at least one scraper plate in response to the interference.

20. The method of claim 19, wherein the at least one scraper plate elastically deflects upon reaching a force being sufficiently high to detach slugs from the worktable slat, the force being sufficiently low to avoid damaging the worktable slat.
